(19) United States
(12) Patent Application Publication
(10) Pub. No.: US 2007/0153413 A1
(43) Pub. Date: Jul. 5, 2007

(54) Active head fault detection scheme

(76) Inventors: Hiromichi Kuwano, Setagaya-ku (JP); Motomu Hashizume, Suginami-ku (JP); Naoko Jinguji, Tamaku (JP)

Correspondence Address: TEXAS INSTRUMENTS INCORPORATED, P O BOX 655474, M/S 3999, DALLAS, TX, 75265, US

(21) Appl. No.: 11/323,790

(22) Filed: Dec. 30, 2005

(51) Int. Cl. G11B 21/02

(52) U.S. Cl. 360/75

(57) ABSTRACT

A system and method of the companion chip monitoring the active head chip over the conventional 4 wire structure, including when the active head chip goes into a sleep state. Advantageously, the companion chip remains operational and detects changes of the voltage on the DX and DY line, even when the active head chip determines a fault and goes into a sleep state. Further, the companion chip can determine which fault was detected by the active head chip using a read back function, such as analyzing an internal register of the active head chip.

### FIELD OF THE INVENTION

The present invention is generally related to hard disk drives, and more particularly to power-off actuator retract circuits utilized in hard disk drives.

### BACKGROUND OF THE INVENTION

A hard disk drive typically includes one or more spinning disks stacked above each other on a spindle, a disk drive controller, a rotary actuator and an actuator retract circuit. These elements typically reside in a chassis or housing and are supplied with external cable connectors.

The rotary actuator consists of an arm equipped with a head for reading and writing data in generally radial and concentric tracks in the recording layers of the individual disk. The actuator is usually driven by an attached voice coil motor (VCM). Cables are connected with the actuator to facilitate transmitting signals to and from the head and to power the VCM. The disk drive controller is typically an electronic circuit that controls all functions of the hard disk drive.

During regular operation of the drive, the controller controls the actuator motions including the movements to and from a parking position, at which parking position the actuator is placed when the drive is not under operation. However, if the power supply to the drive is shut-off unexpectedly, the actuator may not be in the proper parking position. Since the controller requires an external power to operate, it can not park the actuator after unexpected power supply shut-off. Therefore, an independent retract circuit parks the actuator in such cases. Such a retract circuit has to be able to power and control the retraction or withdrawal of the actuator from proximate the disk surface into the parking position within a critical time period during which the spinning disks slow down to a minimal rotational speed. The minimal rotation speed guarantees sufficient supporting air flow between the disk surface and an air bearing surface of the read and write heads to keep them at a minimum flying height. In case the supporting air flow should fall beneath a critical value, the heads are likely to crash and damage the disk surface. Moreover, if the heads were to come to rest on the smooth disk surface, they may adhere to the disk through a process known as stiction.

One method of parking the drive head during a power-off situation is to move it to the parking ramp, typically located inside or outside the disk access area. Each head of the actuator is mounted on a suspension, and a suspension tab is retracted onto a wedge shaped ramp. When the tab reaches the predetermined parking position on the ramp, the actuator is held in place with either a mechanical or inertial latch.

In one common approach, the electrical energy utilized for retracting the head to a parking position is generated by a back electromotive energy generated from the kinetic energy stored in the rotating disk stack. The kinetic energy is thereby converted into a back electromotive voltage (BEMV) by utilizing the disk motor as a generator. The rectified BEMV is electronically connected across the VCM, which generates a torque on the actuator in the desired direction into the parking position.

In another common approach, the electrical energy used for retracting the actuator to the parking position is stored in a capacitor during normal operation, which energy is then released to retract the head into the parked position. One prior art solution uses such a charge capacitor selectively connected to the voice coil of an actuator through switches. Using this technique, the voltage and/or current is not controlled as it is delivered to the voice coil, which can be problematic in that it has difficulty to protect actuator rebound at an outer crash stop when the actuator moving velocity is to high, and that it also has difficulty to apply enough torque to get over the parking ramp.

In yet another conventional technique, the actuator is pulse modulated in an effort to extend the discharge time of the capacitor. The voice coil's self-induction energy is utilized to keep coil current, although there is not an active-controlled voltage across the voice coil. Notably, the actuator velocity is proportional to the applied voltage across the voice coil.

The prior solutions fail to both suppress the initial velocity when the actuator is over the disk, and also generate adequate torque to get the actuator over a parking ramp.

Hard disk drives typically include an active head chip mounted on a suspension preamp, typically known as Chip On Suspension (COS). A companion chip may also be utilized, whereby communications between the active head chip and the companion chip are exchanged over a conventional 4 wire link including control lines DX, DY, and 2 power lines.

It is critical to detect a disorder of a write-head, a read-head, and the active head chip itself, not only for the COS, but also for a conventional preamp. There is desired an improved readability of a hard disk system to detect the fault states of the active head chip on the suspension without changing from the simple 4 wire structure.

### SUMMARY OF INVENTION

The present invention achieves technical advantages as a system and method of the companion chip monitoring the active head chip over the conventional 4 wire structure, including when the active head chip goes into a sleep state. Advantageously, the companion chip remains operational and detects changes of the voltage on the DX and DY line, even when the active head chip determines a fault and goes into a sleep state. Further, the companion chip can determine which fault was detected by the active head chip using a read back function, such as analyzing an internal register of the active head chip.

### BRIEF DESCRIPTION OF THE DRAWINGS

FIG. 1 is a perspective view of a typical multi-disk drive, wherein each head is positionable across the disk during operation, and also retractable over a ramp to a parking position;

FIG. 2 depicts a block diagram of a hard disk drive actuator retract circuit according to the present invention; and

FIG. 3 depicts a logic flow algorithm according to one embodiment of the present invention.

### DETAILED DESCRIPTION OF THE PRESENT INVENTION

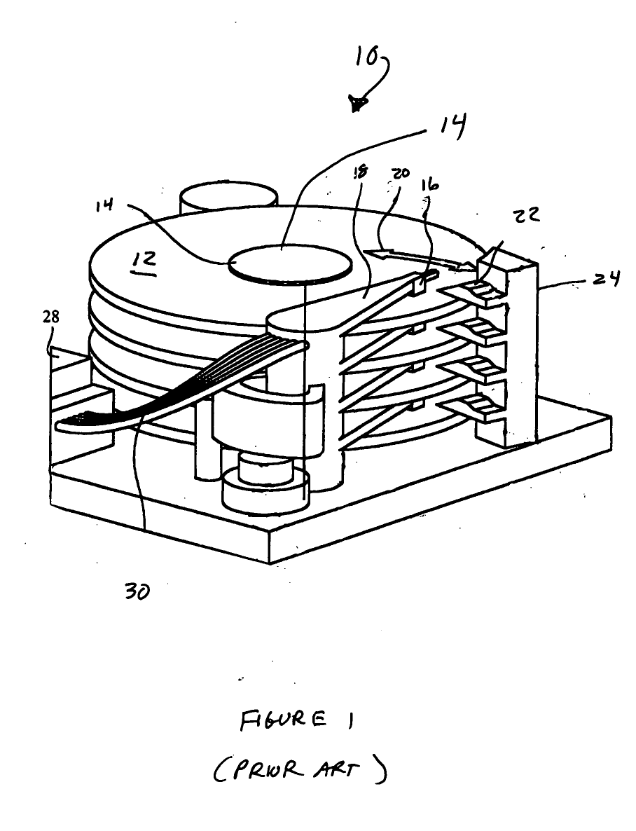

FIG. 1 depicts a conventional hard disk drive 10 having a plurality of disks and associated actuators positionable between an operational position over the disks and a retracted parked position. Each disk 12 is seen to be mounted to a spindle 14 and has associated therewith a head 16 carried by a suspension arm 18. Each head 16 is seen to be positioned via the respective arm 18 across the disk surface as depicted at 20, and is also retractable over a ramp 22 to a parked position distal of the head 22 and over lower portion 24. An actuator control circuit 26 disposed within a housing 28 is coupled to and controls each of the arms 18 via a cable 30.

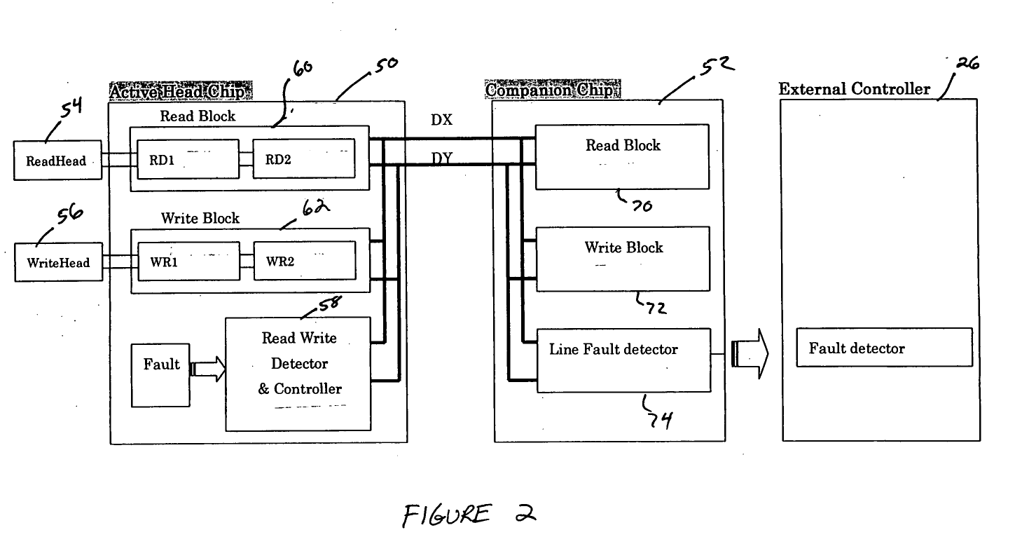

Referring now to FIG. 2, there is depicted an electrical block diagram of an active head fault detection system according to a preferred embodiment of the present invention. An active head chip 50 is seen to be electrically coupled to a companion chip 52 via conventional control lines DX and DY. The active head chip 50 is mounted on the suspension arm 18, as shown in FIG. 1, and communicates with both a read head 54 and a write head 56. The active head chip 50 further is seen to include a read/write detector and controller circuit 58 coupled to control lines DX and DY, and is configured to detect a fault of the active head chip 50 by monitoring voltages on these lines DX and DY.

Still referring to FIG. 2, companion chip 52 includes a read block 70, and a write bock 72 as is conventional. Advantageously, companion chip 52 further includes a line fault detector 74 coupled to control lines DX and DY which is configured to detect a fault operation of the active head chip 50 by detecting the voltages on line DX and DY. When the read/write detector and controller 58 detects as fault of the active head chip 50 by analyzing the voltages on control lines DX and DY, the active head chip 50 changes from any state to a sleep-mode state, and turns off all receiver and driver circuits 60 and 62.

Advantageously, companion chip 52 always watches the voltage levels on lines DX and DY, whether or not the actual voltages thereon fit the current state's DC-voltage range. The companion chip 52 continues normal action when the active head chip 50 goes into the sleep-mode (fault state) and determines the active head chip's fault state by analyzing the voltages on control lines DX and DY, and responsively reports a fault flag to an external controller 26 upon detection of the fault. Such faults can include write head open, short, read head short, open and low voltage of chip, and so forth.

The companion chip 52 determines which fault was detected in the active head chip 50 by detecting a change of the line voltages on control lines DX and DY using a read back function. This read back function is possible because the active head chip 50 reports its fault to an internal register of the companion chip 52 in the line fault detector 74.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A method of detecting a fault state of an active head chip providing control signals on lines DX and DY in a hard disk drive, comprising:
the active head chip changing to a sleep state upon the active head chip detecting a fault state; and
a companion chip monitoring levels created by the active head chip on lines DX and DY, the companion chip maintaining operation when the active head enters the sleep state and determining a fault state upon detecting a change of voltages on lines DX and DY.

2. The method as specified in claim 1 further comprising the companion chip reporting a fault flag to a controller of the hard disk drive upon determining the fault state.

3. The method as specified in claim 2 further comprising the companion chip determining which fault was detected by the active head chip.

4. The method as specified in claim 3 wherein the companion chip determines which fault was detected by detecting a change of line voltage on lines DX and DY using a read back function.

5. The method as specified in claim 4 wherein the method operates using a conventional 4 wire controlling structure including 2 power lines and the DX and DY lines.

6. A hard disk drive fault detection circuit, comprising:
an active head chip configured to control a head of the disk drive over lines DX and DY and change to a sleep state upon detection of a fault state; and
a companion chip electrically coupled to the active head chip via lines DX and DY, the companion chip configured to maintain operation when the active head chip enters the sleep state and determine a fault state of the active head chip by detecting of voltages on lines DX and DY.

7. The circuit as specified in claim 6 further comprising the companion chip configured to report a fault flag to a controller of the hard disk drive upon determining a fault state.

8. The circuit as specified in claim 7 further comprising the companion chip configured to determine which fault was detected by the active head chip.

9. The circuit as specified in claim 8 wherein the companion chip is configured to determine which fault was detected by detecting a change of line voltage on lines DX and DY using a read back function.

10. The circuit as specified in claim 9 wherein the companion chip is configured to operate using a conventional 4 wire controlling structure including 2 power lines and the DX and DY lines.
